(19) United States
(12) Patent Application Publication
(10) Pub. No.: US 2023/0359105 A1
(43) Pub. Date: Nov. 9, 2023

(54) Computer Webcam Cover Device

(71) Applicant: Freda Perry, Brookhaven, GA (US)

(72) Inventor: Freda Perry, Brookhaven, GA (US)

(21) Appl. No.: 18/308,993

(22) Filed: Apr. 28, 2023

Related U.S. Application Data
(60) Provisional application No. 63/338,240, filed on May 4, 2022.

(51) Int. Cl. G03B 11/04; G06F 1/16

(52) U.S. Cl. CPC G03B 11/041; G06F 1/1603

(57) ABSTRACT

A computer webcam cover device is provided. The device is comprised of a rear wall that attaches to the rear of a computer via a fastener. A front wall of the device attaches to the rear wall via a middle wall, wherein the front wall attaches to the middle wall via a fold or a hinge. The front wall covers a webcam of the computer when the webcam is not in use. When the webcam needs to be used, the front wall can be flipped upward about the hinge/fold.

### CROSS-REFERENCE TO RELATED APPLICATION

The present application claims priority to, and the benefit of, U.S. Provisional Application No. 63/338,240, which was filed on May 4, 2022, and is incorporated herein by reference in its entirety.

### FIELD OF THE INVENTION

The present invention relates generally to the field of webcam covers. More specifically, the present invention relates to a computer webcam cover device. The device attaches to the rear surface of a computer, wherein a front wall of the device covers a webcam of the computer when the webcam is not in use. Accordingly, the present disclosure makes specific reference thereto. Nonetheless, it is to be appreciated that aspects of the present invention are also equally applicable to other like applications, devices, and methods of manufacture.

### BACKGROUND

Laptops and desktop computers may be susceptible to hacking such that a hacker can invade the user's privacy by looking through the computer's webcam. Hackers may spy on family members and obtain sensitive information about both children and adults. In addition, children may be on the computer and end up talking to and seeing strangers they do not know. As a result, webcam covers exist in the art which cover the webcam of a computer when not in use. However, said webcam covers adhere to the front surface of a computer screen when in use. This is undesirable, as removing the cover and adhesive from the front surface can crack and damage the front surface. Therefore, many computer companies do not advise placing an adhesive webcam cover on the front surface of a computer screen.

Therefore, there exists a long-felt need in the art for an improved webcam cover. There also exists a long-felt need in the art for a computer webcam cover device that obstructs the view from a webcam when the webcam is not in use. More specifically, there exists a long-felt need in the art for a computer webcam cover device that obstructs the view from a webcam when the webcam is not in use, wherein the device does not attach to the front surface of a computer screen.

The subject matter disclosed and claimed herein, in one embodiment thereof, comprises a computer webcam cover device. The device is primarily comprised of a body comprised of a rear wall comprised of at least one fastener, a middle wall, and a front wall. The rear wall can be secured to a computer via the fastener, wherein the front wall removably covers the webcam of the computer without adhering to the front surface of the computer. When the webcam does not need to be covered, the front wall can be flipped upward to no longer obstruct the webcam. The front wall may attach to the middle wall via a fold or a hinge in different embodiments.

In this manner, the computer webcam cover device of the present invention accomplishes all the foregoing objectives and provides an improved webcam cover. During use, the device obstructs the view from a webcam when the webcam is not in use. While doing so, the device does not attach to the front surface of a computer screen.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer webcam cover device. The device is primarily comprised of a body comprised of a rear wall comprised of at least one fastener, a middle wall, and a front wall. The device is designed to be secured to a computer such that the front wall removably covers the webcam of the computer without adhering to the front surface of the computer. The body may be made from a flexible plastic material or a paper-based material that is opaque such that it covers a webcam that is not in use.

The body is preferably generally U-shaped with a generally parallel rear wall and front wall that are connected by a perpendicular middle wall. The rear wall attaches to the rear surface of the computer via at least one fastener. The fastener may be any type known in the art but is preferably an adhesive fastener or a magnet. The middle wall rests over the top edge of the computer. In one embodiment, the middle wall may also be comprised of at least one fastener that attaches the bottom surface to the top edge for extra adhesion of the device in addition to the fastener of the rear wall.

While blocking the webcam of the computer, the front wall hangs over the front surface of the computer. The front wall does not attach to the front surface via any fastener. As a result, the chance of the front surface becoming cracked/shattered when the device is removed is avoided, unlike existing adhesive webcam covers known in the art.

The front wall connects to the middle wall via at least one hinge. In another embodiment, the front wall connects to the middle via at least one fold. Both the hinge and the fold allow the front wall to be flipped upward such that it does not cover the webcam when the webcam is to be used.

The present invention is also comprised of a method of using the device. First, a device is provided comprised of a rear wall comprised of at least one fastener and a front wall that attaches to the rear wall via a middle wall, wherein the middle wall attaches to the front wall via a hinge or a fold. Then, the fastener of the rear wall adheres to a rear surface of a computer. Then, the front wall can be positioned such that it covers the webcam of the computer. When a user desires to use the webcam, they can then simply fold the front wall upward such that it no longer covers the webcam.

Accordingly, the computer webcam cover device of the present invention is particularly advantageous as it provides an improved webcam cover. During use, the device obstructs the view from a webcam when the webcam is not in use. While doing so, the device does not attach to the front surface of a computer screen. In this manner, the computer webcam cover device overcomes the limitations of existing webcam covers known in the art and provides a device that eliminates the possibility of damaging the front surface of a computer screen while using/removing the device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a computer webcam cover device of the present invention while covering a webcam in accordance with the disclosed architecture;

FIG. 2 illustrates a perspective view of one potential embodiment of a computer webcam cover device of the present invention while covering a webcam in accordance with the disclosed architecture;

FIG. 3 illustrates a perspective view of one potential embodiment of a computer webcam cover device of the present invention while not covering a webcam in accordance with the disclosed architecture; and

FIG. 4 illustrates a flowchart of a method of using one potential embodiment of a computer webcam cover device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved webcam cover. There also exists a long-felt need in the art for a computer webcam cover device that obstructs the view from a webcam when the webcam is not in use. More specifically, there exists a long-felt need in the art for a computer webcam cover device that obstructs the view from a webcam when the webcam is not in use, wherein the device does not attach to the front surface of a computer screen.

The present invention, in one exemplary embodiment, is comprised of a computer webcam cover device primarily comprised of a body comprised of a rear wall comprised of at least one fastener, a middle wall, and a front wall. The device is designed to be secured to a computer such that the front wall removably covers the webcam of the computer without adhering to the front surface of the computer. The body may be made from a flexible plastic material or a paper-based material that is opaque such that it covers a webcam that is not in use.

The body is also preferably generally U-shaped with a generally parallel rear wall and front wall. The front and rear walls are connected by a perpendicular middle wall. The rear wall attaches to the rear surface of the computer via at least one fastener. The fastener may be any type known in the art but is preferably an adhesive fastener or a magnet. The middle wall rests over the top edge of the computer. In one embodiment, the middle wall may also be comprised of at least one fastener that attaches the bottom surface to the top edge for extra adhesion of the device in addition to the fastener of the rear wall.

While blocking the webcam of the computer, the front wall hangs over the front surface of the computer. The front wall does not attach to the front surface via any fastener. Therefore, the chance of the front surface becoming cracked/shattered when the device is removed is avoided, unlike existing adhesive webcam covers known in the art.

The front wall connects to the middle wall via at least one hinge. In another embodiment, the front wall connects to the middle wall via at least one fold. Both the hinge and the fold allow the front wall to be flipped upward such that it does not cover the webcam when the webcam is to be used.

The present invention is also comprised of a method of using the device. First, a device is provided comprised of a rear wall comprised of at least one fastener and a front wall that attaches to the rear wall via a middle wall, wherein the middle wall attaches to the front wall via a hinge or a fold. Then, the fastener of the rear wall adheres to a rear surface of a computer. Then, the front wall can be positioned such that it covers the webcam of the computer. When a user desires to use the webcam, they can then simply fold the front wall upward such that it no longer covers the webcam.

Accordingly, the computer webcam cover device of the present invention is particularly advantageous as it provides an improved webcam cover. During use, the device obstructs the view from a webcam when the webcam is not in use. While doing so, the device does not attach to the front surface of a computer screen. In this manner, the computer webcam cover device overcomes the limitations of existing webcam covers known in the art and provides a device that eliminates the possibility of damaging the front surface of a computer screen while using/removing the device.

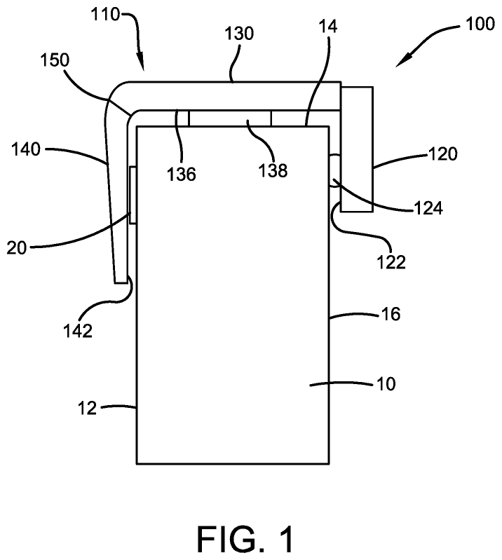

Referring initially to the drawings, FIG. 1 illustrates a side view of one potential embodiment of a computer webcam cover device 100 of the present invention while covering a webcam 20 in accordance with the disclosed architecture. The device 100 is primarily comprised of a body 110 comprised of a rear wall 120 comprised of at least one fastener 124, a middle wall 130, and a front wall 140. The device 100 is designed to be secured to a computer 10 such that the front wall 140 removably covers the webcam 20 of the computer 10 without adhering to the front surface 12 of the computer 10.

In differing embodiments, the body 110 may be made from a flexible plastic material or a paper-based material. The material is opaque to cover the webcam 20 of a computer 10 the device 100 is placed on when the webcam 20 is not in use to ensure privacy. The body 110 may be comprised of at least one indicia 160 such as, but not limited to, a pattern, a simulated texture, an image, etc., for aesthetic purposes.

The body 110 is preferably generally U-shaped with a generally parallel rear wall 120 and front wall 140 connected by a perpendicular middle wall 130. The rear wall 120 attaches to the rear surface 16 of the computer 10, as best seen in FIG. 1. More specifically, the front surface 122 of the rear wall 120 is comprised of at least one fastener 124 that attaches the rear wall 120 to the rear surface 16. The fastener 124 may be any type known in the art but is preferably an adhesive fastener or a magnet.

The middle wall 130 rests over the top edge 14 of the computer 10. In one embodiment, the bottom surface 136 of the middle wall 130 is comprised of at least one fastener 138. The fastener 138 attaches the bottom surface 136 to the top edge 14 for extra adhesion of the device 100 in addition to the fastener 124 of the rear wall 120. The fastener 124 may be any type known in the art but is preferably an adhesive fastener or a magnet.

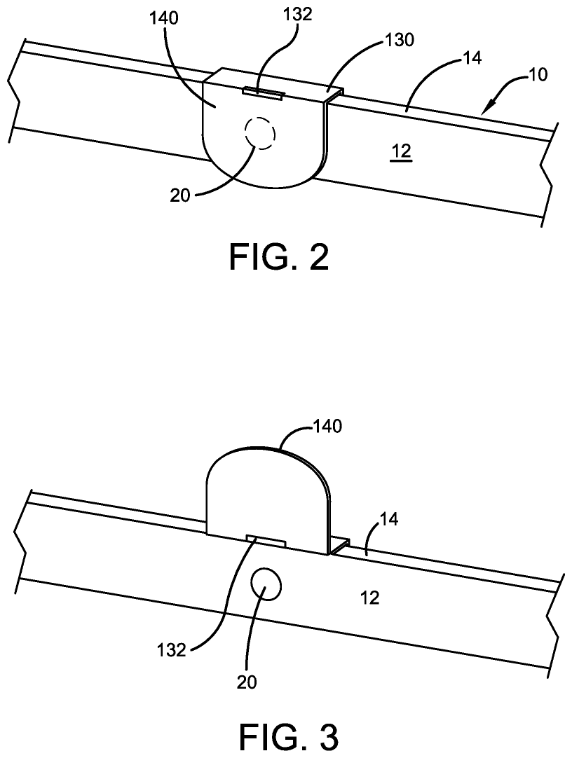

While blocking the webcam 20, the front wall 140 of the device hangs over the front surface 12 of the computer 10, as seen in FIG. 2. It should be noted that the front wall 140 does not attach to the front surface 12 via any fastener. In this manner, the chance of the front surface 12 becoming cracked/shattered when the device 100 is removed is avoided, unlike existing adhesive webcam covers known in the art. In one embodiment, the rear surface 142 of the front wall 140 is comprised of a soft, fabric material to ensure the rear surface 142 does not scratch the webcam 20.

In one embodiment, the front wall 140 connects to the middle wall 130 via at least one hinge 132 of any type known in the art. In another embodiment, the front wall 140 connects to the middle 130 via at least one fold 150. Both the hinge 132 and the fold 150 allow the front wall 140 to be flipped upward, such that it does not cover the webcam 20 (as seen in FIG. 3), when the webcam 20 must be used.

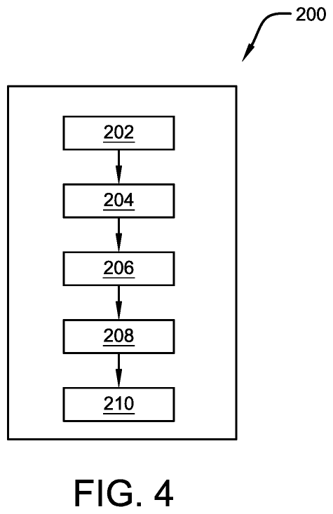

The present invention is also comprised of a method of using 200 the device 100, as seen in FIG. 4. First, a device 100 is provided comprised of a rear wall 120 comprised of at least one fastener 124 and a front wall 140 that attaches to the rear wall 120 via a middle wall 130, wherein the middle wall 130 attaches to the front wall 140 via a hinge 132 or a fold 150 [Step 202]. Then, the fastener 124 of the rear wall 120 adheres to a rear surface 16 of a computer 10 [Step 204]. In an embodiment wherein the bottom surface 136 of the middle wall 130 is comprised of at least one fastener 138, said fastener 138 can be attached to the top edge 14 of the computer 10 [Step 206]. Then, the front wall 140 can be positioned such that it covers the webcam 20 of the computer [Step 208]. When a user desires to the use the webcam 20, they can then simply fold the front wall 140 upward such that it no longer covers the webcam 20 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “computer webcam cover device” and “device” are interchangeable and refer to the computer webcam cover device 100 of the present invention.

Notwithstanding the foregoing, the computer webcam cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the computer webcam cover device 100 as shown in the FIGS. are for illustrative purposes only, and that many other sizes and shapes of the computer webcam cover device 100 are well within the scope of the present disclosure. Although the dimensions of the computer webcam cover device 100 are important design parameters for user convenience, the computer webcam cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer webcam cover device comprising:
a middle wall;
a rear wall that attaches to the middle wall;
a fastener positioned on a front surface of the rear wall; and
a front wall that attaches to the middle wall.

2. The computer webcam cover device of claim 1, wherein the front wall attaches to the middle wall via a fold.

3. The computer webcam cover device of claim 1, wherein the fastener is comprised of an adhesive fastener.

4. The computer webcam cover device of claim 1, wherein the fastener is comprised of a magnet.

5. The computer webcam cover device of claim 1, wherein the front wall, the middle wall, and the rear wall are comprised of a flexible plastic material.

6. The computer webcam cover device of claim 1, wherein the front wall is generally parallel to the rear wall.

7. The computer webcam cover device of claim 1, wherein the middle wall is generally perpendicular to the front wall and the rear wall.

8. A computer webcam cover device comprising:
a middle wall;
a rear wall that attaches to the middle wall;
a first fastener positioned on a front surface of the rear wall; and
a front wall that attaches to the middle wall via a hinge.

9. The computer webcam cover device of claim 8, wherein a bottom surface of the middle wall is comprised of a second fastener.

10. The computer webcam cover device of claim 8, wherein the first fastener is comprised of an adhesive fastener.

11. The computer webcam cover device of claim 8, wherein the first fastener is comprised of a magnet.

12. The computer webcam cover device of claim 9, wherein the second fastener is comprised of an adhesive fastener.

13. The computer webcam cover device of claim 9, wherein the second fastener is comprised of a magnet.

14. The computer webcam cover device of claim 8, wherein a rear surface of the front wall is comprised of a fabric material.

15. The computer webcam cover device of claim 8, wherein the front wall, the middle wall, and the rear wall are comprised of a paper-based material.

16. The computer webcam cover device of claim 8, wherein the front wall is generally parallel to the rear wall.

17. The computer webcam cover device of claim 8, wherein the middle wall is generally perpendicular to the front wall and the rear wall.

18. A method of using a computer webcam cover device, the method comprising the following steps:
providing a computer webcam cover device comprised of a rear wall comprised of a fastener and a front wall that attaches to the rear wall via a middle wall wherein the middle wall also attaches to the front wall;
adhering the fastener to a rear surface of a computer;
positioning the front wall such that it covers a webcam of the computer; and
folding the front wall upwards such that it no longer covers the webcam.

19. The method of claim 18, wherein the middle wall attaches to the front wall via a fold.

20. The method of claim 18, wherein the middle wall attaches to the front wall via a hinge.
